(19) United States
(12) Patent Application Publication
(10) Pub. No.: US 2014/0029252 A1
(43) Pub. Date: Jan. 30, 2014

(54) LAMP, LAMP UNIT, AND LUMINAIRE

(71) Applicant: TOSHIBA LIGHTING & TECHNOLOGY CORPORATION, Kanagawa (JP)

(72) Inventors: Go KATO, Yokosuka (JP); Masahiko Kamata, Yokosuka (JP); Junichi Kimiya, Yokosuka (JP); Kenji Nezu, Yokosuka (JP); Yoshiyuki Tamaki, Yokosuka (JP); Hiroto Nakamura, Yokosuka (JP); Makoto Otsuka, Tokyo (JP); Yoshiyuki Tomizawa, Tokyo (JP)

(73) Assignee: Toshiba Lighting & Technology Corporation, Kanagawa (JP)

(21) Appl. No.: 13/664,075

(22) Filed: Oct. 30, 2012

(30) Foreign Application Priority Data
Jul. 30, 2012 (JP) 2012-168896

(51) Int. Cl. F21V 21/00; H01R 43/26; F21V 5/04

(52) U.S. Cl. 362/235; 362/249.01; 362/249.02; 29/825; 29/854

(57) ABSTRACT

According to one embodiment, an LED lamp includes a lighting circuit, a storage, a thermal radiating body, an LED substrate, and a cover. The storage includes a pair of electrode pins electrically connected to the lighting circuit, and stores the lighting circuit in the interior thereof. The thermal radiating body integrally includes a lid portion configured to cover the storage and an arrangement portion located in a periphery of the lid portion. The LED substrate includes an LED configured to emit light upon receipt of power feed from the lighting circuit, and is arranged so as to be thermally connected to the arrangement portion of the thermal radiating body. The cover has translucency and covers the LED substrate.

### INCORPORATION BY REFERENCE

The present invention claims priority under 35 U.S.C. §119 to Japanese Patent Application No. 2012-168896 filed on Jul. 30, 2012. The content of the application is incorporated herein by reference in their entirety.

### FIELD

Embodiments described herein relate generally to a lamp having a lighting circuit stored in an interior of a storage, a lamp unit having the lamp, and a luminaire having the lamp.

### BACKGROUND

In the related art, there is a lamp unit using a cap of so-called GX53 type having a pair of electrode pins. The lamp of this type has a flat cylindrical shape as a whole and is configured in such a manner that an LED substrate, which corresponds to a light source substrate having LEDs as light sources mounted thereon, is thermally connected to a surface of a flat metallic body portion, a cap case portion in which a lighting circuit for feeding power to be electrically connected to the electrode pins is stored is arranged on a back surface of the body portion, and the LED substrate is covered with a reflecting member or the like mounted on the body portion.

### BRIEF DESCRIPTION OF THE DRAWINGS

FIG. 1 illustrates an exploded perspective view of a lamp according to a first embodiment viewed from below;

FIG. 2 illustrates a cross-sectional view of the lamp;

FIG. 3 illustrates a partly enlarged cross-sectional view of the lamp;

FIG. 4 illustrates a plan view of the lamp in a state in which a cover thereof is removed therefrom viewed from below;

FIG. 5 illustrates a plan view of a storage of the lamp viewed from below;

FIG. 6 illustrates a plan view of the lamp viewed from below;

FIG. 7 illustrates a plan view of the lamp viewed from above;

FIG. 8 illustrates a schematic side view of a luminaire provided with a lamp unit having the lamp;

FIG. 9 illustrates an exploded perspective view of the lamp according to a second embodiment viewed from below;

FIG. 10 illustrates a partly enlarged cross-sectional view of the lamp;

FIG. 11 illustrates another partly enlarged cross-sectional view of the lamp;

FIG. 12 illustrates a plan view of the lamp viewed from below;

FIG. 13 illustrates a plan view of the lamp viewed from above;

FIG. 14 illustrates a cross-sectional view of the lamp according to a third embodiment;

FIG. 15 is a partly enlarged cross-sectional view of the lamp according to a fourth embodiment;

FIG. 16 illustrates another partly enlarge cross-sectional view of the lamp;

FIG. 17 illustrates a partly enlarged cross-sectional view of the lamp according to a fifth embodiment;

FIG. 18 illustrates a plan view of the lamp with a cover thereof removed therefrom viewed from below;

FIG. 19 illustrates a plan view of the storage of the lamp viewed from below;

FIG. 20 illustrates a plan view of the lamp viewed from below;

FIG. 21 illustrates a plan view of the lamp viewed from above; and

FIG. 22 illustrates a schematic side view of the luminaire according to a sixth embodiment.

### DETAILED DESCRIPTION

A lamp of the embodiment includes a lighting circuit, a storage, a thermal radiating body, a light source substrate, and a cover. The storage includes a pair of electrode pins electrically connected to the lighting circuit, and is configured to store the lighting circuit in the interior thereof. The thermal radiating body integrally includes a lid portion configured to cover the storage and an arrangement portion located in the periphery of the lid portion. The light source substrate includes a light source configured to emit light upon receipt of power feed from the lighting circuit, and is arranged so as to be thermally connected to the arrangement portion of the thermal radiating body. The cover has translucency and covers the light source substrate.

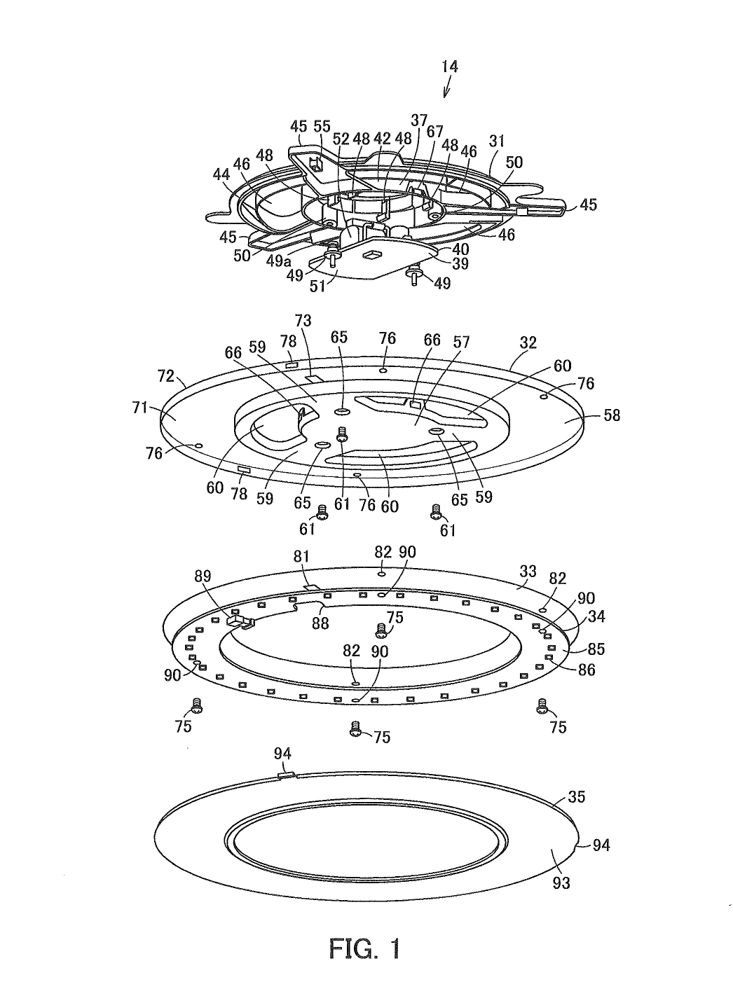

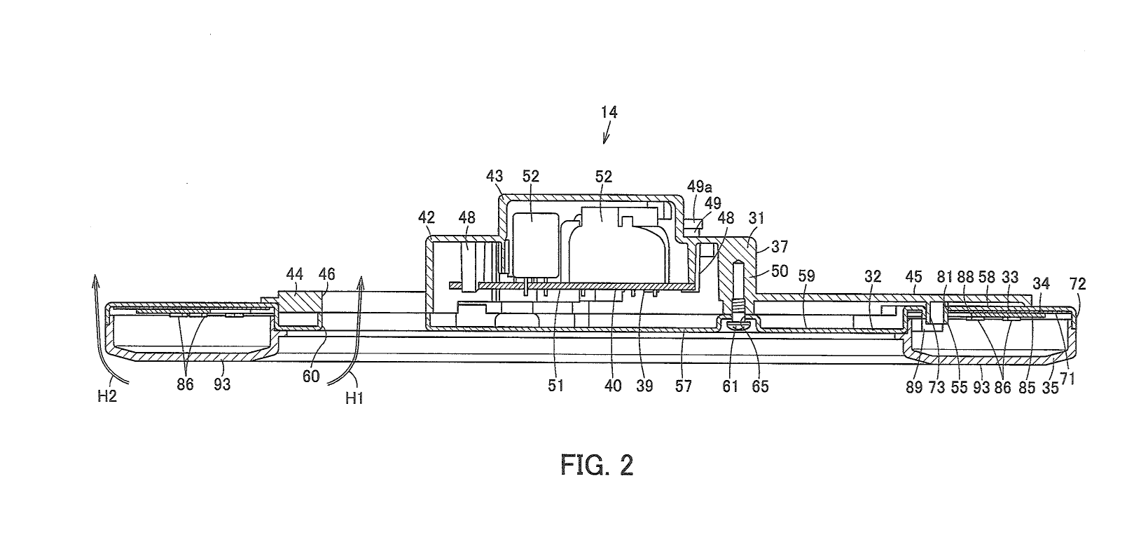

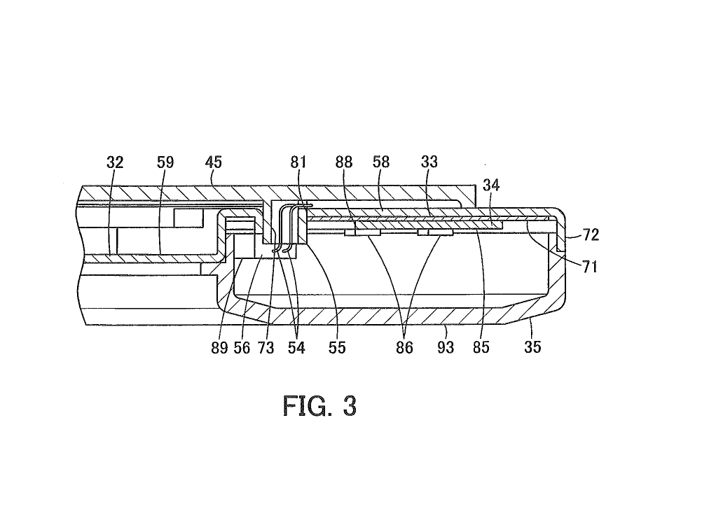

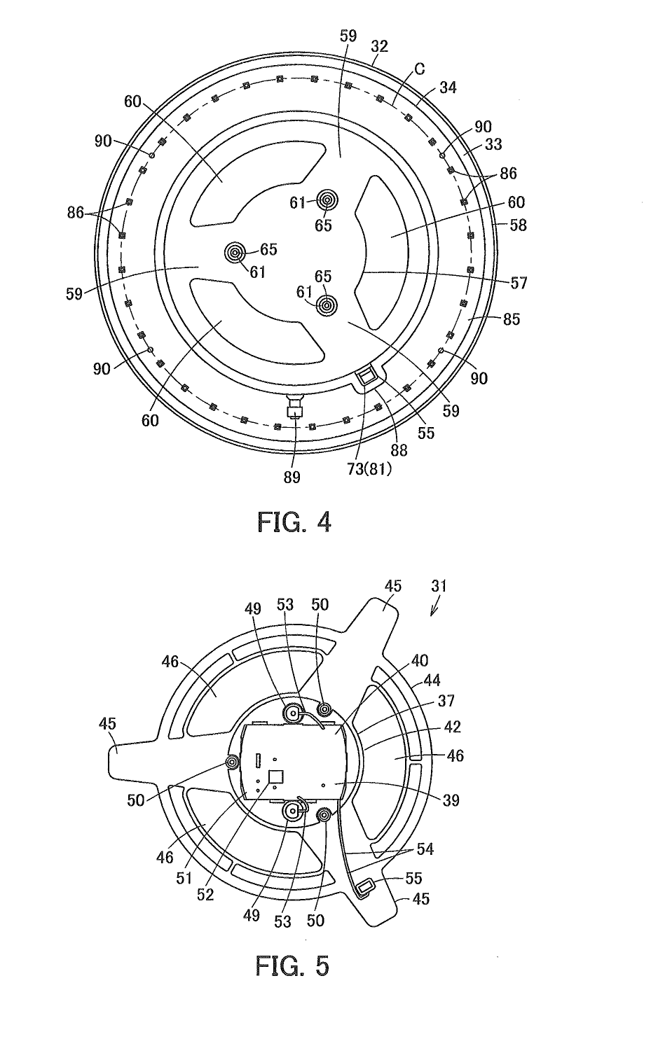

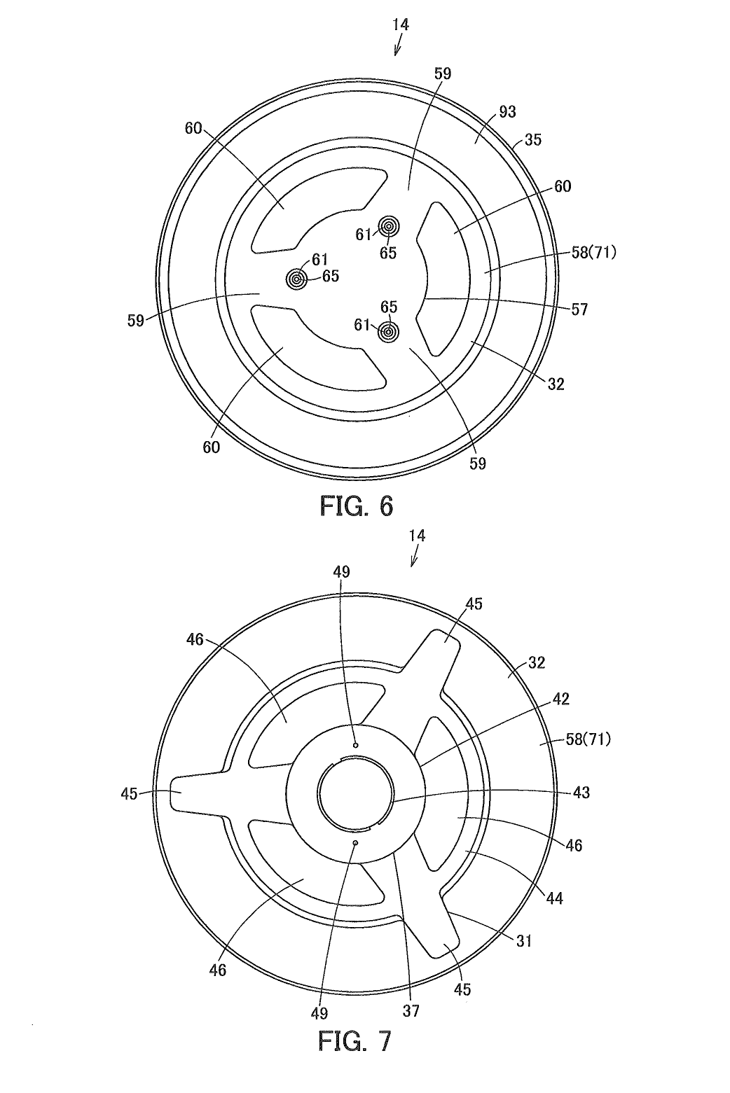

Referring now to FIG. 1 to FIG. 8, a configuration of the first embodiment will be described.

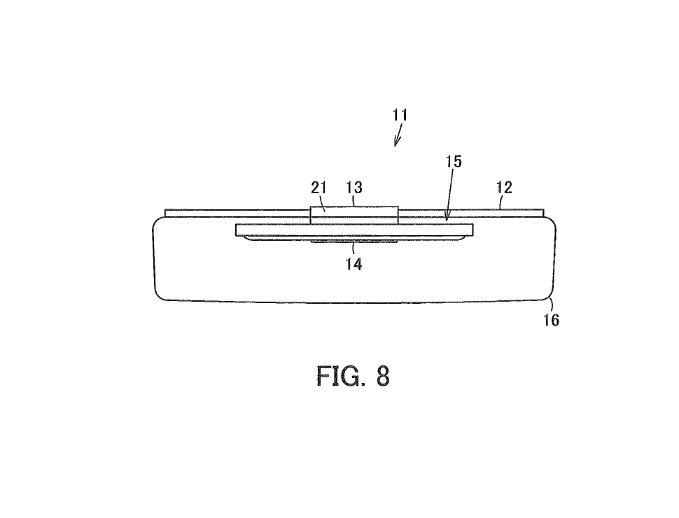

As illustrated in FIG. 8, a luminaire 11 includes a luminaire body 12 installed on a ceiling surface, a lamp unit 15 provided with a socket 13 to be mounted at a center portion or the like of the luminaire body 12 and an LED lamp 14 as a lamp mountable and demountable with respect to the socket 13, and a globe 16 configured to cover the lamp unit 15. The directional relationship such as upward and downward directions thereof is described assuming that the side of the luminaire body 12 and the socket 13 is an upper side, and the side of the lamp unit 15 is a lower side with reference to a state in which the lamp unit 15 is mounted horizontally.

The socket 13 corresponds to a so-called GX53 type cap, includes a flat cylindrical socket body 21 formed of synthetic resin having electric insulating properties, and is formed with an insertion hole, not illustrated, at a center portion of the socket body 21. In addition, socket openings, not illustrated, are formed at symmetrical positions with respect to the center portion on a lower surface of the socket body 21. The respective socket openings are formed into an elongated hole shaped shape curved into an arcuate shape, and are provided with sockets electrically connected to an external power supply (commercial power supply) for supplying power arranged in the interiors thereof. Furthermore, the socket openings are each formed with a wider diameter portion at one end thereof.

As illustrated in FIG. 1 to FIG. 8, the LED lamp 14 includes a storage 31 as a cap case, a thermal radiating body as a metallic housing, an insulating sheet 33 as an insulating member, an LED substrate 34 which is a light-emitting element substrate as a light source substrate, and a cover 35 as a lamp globe integrally assembled from the upper side to the lower side into a thin cylindrical shape.

The storage 31 includes, for example, a GX53 type cap portion structure and is formed of a synthetic resin having electrical insulating properties. The storage 31 includes a storage body 37, and includes a power supply substrate 40 on which a lighting circuit 39 is mounted, in the interior thereof.

The storage body 37 integrally includes a flat base body portion 42, a base body projecting portion 43 projecting from a center portion of the base body portion 42, an annular-shaped peripheral edge portion 44 located at a position apart outward from the base body portion 42, that is, in the periphery of the base body portion 42, and a plurality of, for example, three coupling arm portions 45 formed radially along the radial direction and coupling the base body portion 42 and the peripheral edge portion 44. Then, the storage body 37 is provided with air ventilation openings 46 as piercing openings on an outer peripheral side of the base body portion 42, on an inner peripheral side of the peripheral edge portion 44, and between the coupling arm portions 45 and 45, respectively.

The base body portion 42 has a flat cylindrical shape having a lid, and is provided with a plurality of holding portions 48 for holding the power supply substrate 40 (the lighting circuit 39) in the interior thereof so as to project downward. Electrode pins 49 and 49 are inserted through the base body portion 42 from the inside (lower side) at symmetrical positions with respect to the center portion and exposed. Each of the electrode pins 49 is formed into a column shape and includes an enlarged portion 49a fitting to the wider diameter portion of each of the socket openings of the socket 13 on the distal end sides thereof. Therefore, when the LED lamp 14 is rotated (turned) in the circumferential direction in a state in which the enlarged portion 49a are inserted into and fitted to the wider diameter portion of the socket openings of the socket 13, the enlarged portions 49a of the electrode pins 49 are locked to the other end sides of the socket openings, and are electrically connected to the socket, and the LED lamp 14 is connected and fixed to the socket 13 (the luminaire body 12). Furthermore, screw receiving portions 50 formed into a boss shape are formed at positions on an outer peripheral edge portion of the base body portion 42 at positions corresponding to the proximal ends of the coupling arm portions 45.

The base body projecting portion 43 is formed into a flat cylindrical shape having a lid and is set to have a diameter smaller than the base body portion 42. Then, the base body projecting portion 43 is inserted into an insertion hole of the socket body 21 in a state in which the LED lamp 14 is mounted on the socket 13.

The respective coupling arm portions 45 are formed so as to be gradually narrower from the proximal end sides (inner sides) to distal end sides (outer sides). In addition, the distal end sides of the coupling arm portions 45 project outward from an outer peripheral edge of the peripheral edge portion 44.

The lighting circuit 39 is a circuit for converting power fed from the external power supply (commercial power supply), not illustrated, via the electrode pins 49 and 49 and feeding power to the LED substrate 34.

Then, the power supply substrate 40 includes a power source substrate body 51 and electronic components 52 mounted on the power source substrate body 51 and constituting the lighting circuit 39, and is held and fixed to the holding portions 48 of the base body portion 42 of the storage body 37. The electronic components 52 are located by being partly fitted into the interior of the base body projecting portion 43 in a state of holding the power source substrate body 51 in the holding portions 48. Furthermore, wires 53 to be electrically connected to respective electrode pins 49 and a plurality of wires 54 electrically connected to the LED substrate 34 are led out respectively to the power supply substrate 40. The wires 54 are arranged along either one of the coupling arm portions 45 of the storage 31, are inserted through a square-tube-shaped wire insertion portion 55 projecting at a position outward of an outer edge portion of the peripheral edge portion 44 at the corresponding coupling arm portion 45, and are guided toward the LED substrate 34. Distal end sides of the wires 54 are connected to a single connector 56.

The thermal radiating body 32 is formed of a metal such as aluminum superior in thermal radiation properties and thermal conductivity into a thin plate shape. The thermal radiating body 32 integrally includes a circular lid portion 57 configured to cover the storage 31, an annular arrangement portion 58 located at an outer periphery of the lid portion 57, and a plurality of, for example, three coupling portions 59 formed radially along the radial direction and configured to couple the lid portion 57 and the arrangement portion 58. Therefore, the thermal radiating body 32 is provided with openings 60 respectively on an outer peripheral side of the lid portion 57, an inner peripheral side of the arrangement portion 58, and between the coupling portions 59 and 59. Then, the thermal radiating body 32 is fixed to the storage 31 with a plurality of screws 61 as thermal radiating body fixing members.

The lid portion 57 is formed into a circular shape that covers the storage body 37 of the storage 31 entirely. Provided in the vicinity of an outer peripheral edge portion of the lid portion 57 are screw holes 65 for allowing insertion of the screws 61 at positions corresponding to the proximal ends of the respective coupling portion 59. The screw holes 65 communicate with the screw receiving portions 50 of the storage 31, respectively, in a state in which the thermal radiating body 32 is mounted on the storage 31, so that the screws 61 inserted into the screw holes 65 are configured to be screwed to the screw receiving portions 50. In addition, the outer peripheral edge portion of the lid portion 57 is bent and projects upward, and the outer peripheral edge portion is formed with hook receiving portions 66 as thermal-radiating-body-side engaging portions at center portions of each of the openings 60 for preventing the rotation of and achieving positioning of the thermal radiating body 32 with respect to the storage 31 so as to project upward, that is, toward the storage 31, respectively. The hook receiving portions 66 are formed into a loop and are configured to be engaged with the hooking portions 67 as hook-shaped storage-body-side engaging portions projecting from an outer periphery of the base body portion 42 of the storage body 37 in a state in which the thermal radiating body 32 is mounted on the storage 31.

The arrangement portion 58 integrally includes an arrangement surface portion 71 formed into an annular flat plate shape as an arrangement surface of LED substrate 34 and a bent portion 72 bent and projecting downward from an outer peripheral edge of the arrangement surface portion 71. A square hole shaped opening 73 is provided in the vicinity of an inner peripheral edge of the arrangement surface portion 71, that is, at a position in the vicinity of an outer peripheral edge of the lid portion 57. Also, a plurality of screw holes 76 for fixing the LED substrate 34 to the thermal radiating body 32 with a plurality of screws 75 as fixing members are provided in the vicinity of the outer peripheral edge of the arrangement surface portion 71. The bent portion 72 is provided with a plurality of square hole shaped locking openings 78 for locking the cover 35 to the thermal radiating body 32.

The opening 73 is located at a position adjacent to the outer peripheral edge of the lid portion 57, and the wire insertion portion 55 is inserted in a state in which the thermal radiating body 32 is mounted on the storage 31. A distal end side of the wire insertion portion 55 inserted into the opening 73 projects downward which is the cover 35 side with respect to a lower surface of the arrangement portion 58 (the arrangement surface portion 71) of the thermal radiating body 32, so that interference between the respective wires 54 and edge portions of the opening 73 is prevented.

Also, the respective coupling portions 59 are portions covering the proximal end sides of the respective coupling arm portions 45 of the storage 31 and are formed so as to be gradually narrower from the proximal end sides (inner sides) to the distal end sides (outer sides).

The insulating sheet 33 is configured to insulate the thermal radiating body 32 from the LED substrate 34, is formed into an annular shape, and is mounted and fixed together with the LED substrate 34 so as to cover the lower surface of the arrangement surface portion 71 of the arrangement portion 58 of the thermal radiating body 32. The insulating sheet 33 is set to have a widthwise dimension substantially equal to the arrangement surface portion 71, and covers the lower surface of the arrangement surface portion 71 substantially entirely. Furthermore, the insulating sheet 33 is provided with a square-hole-shaped communication opening 81 communicating with the opening 73 of the thermal radiating body 32 and allowing insertion of the respective wires 54 therethrough at a position on the inner peripheral edge side. Furthermore, the insulating sheet 33 is provided respectively with communication holes 82 communicating with the respective screw holes 76 of the thermal radiating body 32 at positions in the vicinity of the outer peripheral edge thereof.

The LED substrate 34 is referred to as an LED module, and integrally includes an annular flat plate shaped substrate body 85, and a plurality of LEDs 86 as light sources which is solid light-emitting elements mounted on the substrate body 85.

The substrate body 85 is set to have a width narrower than the arrangement surface portion 71 of the arrangement portion 58. Therefore, an inner peripheral edge and an outer peripheral edge of the LED substrate 34 are offset by a predetermined width with respect to the inner peripheral edge and the outer peripheral edge of the arrangement surface portion 71 (the insulating sheet 33) of the arrangement portion 58 respectively in a state of being mounted on the arrangement surface portion 71 of the arrangement portion 58. The substrate body 85 is formed with a notched opening 88 communicating with the opening 73 of the thermal radiating body 32 and the communication opening 81 of the insulating sheet 33 to allow insertion of the respective wires 54 therethrough on an inner peripheral edge thereof. In addition, a connector receiving portion 89 to which the respective wires 54 led out from the notched opening 88 (the opening 73 and the communication opening 81) are electrically connected via the connector 56 are mounted on the lower surface of the substrate body 85 in the vicinity of the notched opening 88. The substrate body 85 is provided with through holes 90 communicating with the screw holes 76 of the thermal radiating body 32 and the respective communication holes 82 of the insulating sheet 33, and allowing insertion of the screws 75, respectively.

The respective LEDs 86 are, for example, surface-mounted elements formed by covering LED chips emitting blue light with a resin sealing layer of a yellow light-emitting system, and are arranged apart from each other at substantially regular intervals along above a predetermined row (imaginary circle C) at positions on the outer peripheral side of the lower surface of the substrate body 85, that is, the surface facing the cover 35. The imaginary circle C is a circle concentric with the substrate body 85, and the through holes 90 are located on the imaginary circle C. Therefore, the LED substrate 34 is fixed to the thermal radiating body 32 at positions on the imaginary circle C with the respective screws 75, and is thermally connected to the thermal radiating body 32.

The cover 35 is formed of a synthetic resin having translucency, and is formed into an annular shape corresponding to the arrangement portion 58 (the arrangement surface portion 71) of the thermal radiating body 32. The cover 35 integrally includes an annular band shaped covering portion 93 facing a lower side (light-emitting side) of the LED substrate 34 (the LEDs 86), and locking claw portions 94 as locking portions provided on an outer peripheral edge of the covering portion 93 for locking the cover 35 to the thermal radiating body 32.

The covering portion 93 is formed into a planar shape, and is located below the LED substrate 34 so as to apart therefrom.

The locking claw portions 94 are portions inserted into and locked to the locking openings 78 of the thermal radiating body 32 and are formed into a claw shape on the outer peripheral edge of the covering portion 93.

The globe 16 is formed of a synthetic resin having translucency or the like into, for example, a bottomed cylindrical-shape having an upper side thereof opened, and is configured to cover the LED lamp 14 (the lamp unit 15) and diffuse light emitted from the LED lamp 14 (the LEDs 86).

Subsequently, the operation of the first embodiment will be described.

When assembling the LED lamp 14, first of all, the power supply substrate 40 (the lighting circuit 39) on which the electronic components 52 are mounted on the power source substrate body 51 is inserted into the storage body 37 of the storage 31 having the respective electrode pins 49 mounted thereon and are held by the holding portions 48, and the respective electrode pins 49 and the power supply substrate 40 are electrically connected by using the respective wires 53. The respective wires 54 led out from the power supply substrate 40 are drawn out along above any one of the coupling arm portions 45, are inserted through the wire insertion portion 55 and are led out to the lower side of the storage 31.

Subsequently, the thermal radiating body 32 is mounted on the storage 31. At this time, the thermal radiating body 32 aligns the respective coupling portions 59 with the respective coupling arm portions 45 of the storage 31, aligns the respective screw holes 65 with the respective screw receiving portions 50, and pushes the respective hook receiving portions 66 toward the storage 31 while aligning with respective hooking portions 67, so that the respective hooking portions 67 engage the respective hook receiving portions 66, and the thermal radiating body 32 is temporarily locked to the storage 31. At this time, the respective wires 54 and the connector 56 led out from the wire insertion portion 55 are inserted into the opening 73 of the arrangement surface portion 71 of the arrangement portion 58, and is led out to a lower side of the arrangement surface portion 71. Then, the screws 61 are inserted into the respective screw holes 65, and are screwed into the respective screw receiving portions 50, so that the thermal radiating body 32 is mounted on and fixed to the storage 31. In this state, the thermal radiating body 32 covers the base body portion 42 of the storage body 37 of the storage 31 with the lid portion 57, the respective coupling arm portions 45 of the storage 31 are located on an upper surface, which corresponds to back surfaces of the coupling portions 59, and the arrangement portion 58 is located in the periphery outward of the lid portion 57 (the storage 31).

Then, the LED substrate 34 formed by mounting the LEDs 86 and the connector receiving portion 89 and the like on the substrate body 85 in advance is mounted on the thermal radiating body 32 via the insulating sheet 33. At this time, the insulating sheet 33 aligns the communication opening 81 with the opening 73 of the thermal radiating body 32, and aligns the respective communication holes 82 with the respective screw holes 76 of the thermal radiating body 32. The LED substrate 34 aligns the notched opening 88 of the substrate body 85 with the communication opening 81 of the insulating sheet 33 and the opening 73 of the thermal radiating body 32, and aligns the respective through holes 90 with the respective communication holes 82 of the insulating sheet 33 and the respective screw holes 76 of the thermal radiating body 32. In this state, the screws 75 are inserted into the respective through holes 90 and the respective communication holes 82 and screwed into the respective screw holes 76, so that the LED substrate 34 is mounted on and fixed to the arrangement surface portion 71 of the arrangement portion 58 of the thermal radiating body 32 via the insulating sheet 33. The respective wires 54 and the connector 56 led out from the opening 73 of the thermal radiating body 32, are led out from the communication opening 81 of the insulating sheet 33 and the notched opening 88 of the LED substrate 34, and the connector 56 is connected to the connector receiving portion 89, whereby the lighting circuit 39 is electrically connected to the respective LEDs 86.

Then, the cover 35 is mounted on the thermal radiating body 32 so as to cover the LED substrate 34. At this time, the cover 35 pushes the respective locking claw portions 94 toward the thermal radiating body 32 while aligning with the respective locking openings 78 of the thermal radiating body 32, so that the locking claw portions 94 engage the locking openings 78, respectively. Consequently, the covering portion 93 of the cover 35 is brought into a state of covering the respective LEDs 86 of the LED substrate 34.

The LED lamp 14 assembled in this manner is mounted on the luminaire body 12 by being turned in the circumferential direction in a state in which the respective electrode pins 49 are inserted into the wider diameter portion of the socket openings of the socket 13, so that the respective electrode pins 49 are electrically connected to the external power supply (commercial power supply) via the sockets. Thereafter, the globe 16 is mounted on the luminaire body 12 so as to cover the LED lamp 14, whereby the luminaire 11 is completed.

Power supplied from the external power supply (commercial power supply) to the lighting circuit 39 via the respective electrode pins 49 by the socket 13 is converted by the lighting circuit 39 and supplied to the respective LEDs 86, so that the LEDs 86 are turned ON. The light emitted from the respective LEDs 86 is irradiated by being diffused by the covering portion 93 of the cover 35 and being diffused by the globe 16.

Heat from the lighting circuit 39 is transferred to the lid portion 57 of the thermal radiating body 32 which covers the lighting circuit 39. Heat from the LED substrate 34 (the LEDs 86) is transferred from the substrate body 85 to the arrangement portion 58 of the thermal radiating body 32 via the insulating sheet 33. Therefore, a heat generating area is separated by the lighting circuit 39 and the LED substrate 34 (the LEDs 86), and local (partial) trapping (accumulation) of heat is minimized. Simultaneously, the thermal radiating body 32 secures a large surface area owing to the lid portion 57 and hence radiates heat from the LED substrate 34 (the LEDs 86) effectively to the atmospheric air.

Specifically, the thermal radiating body 32 generates thermal convection toward an inner peripheral side and an outer peripheral side of the arrangement portion 58 which receives the heat from the LED substrate 34 (the LEDs 86), and the heat is radiated effectively to the atmospheric air by passage of outside air through the openings 60 (the air ventilation openings 46 of the storage 31) located between the lid portion 57 covering the lighting circuit 39 and the arrangement portion 58 where the LED substrate 34 is arranged (arrows H1, H2).

As described above, according to the first embodiment described above, the thermal radiating body 32 is integrally provided with the lid portion 57 configured to cover the storage 31 in which the lighting circuit 39 is stored in the interior thereof and the arrangement portion 58 located in the periphery of the lid portion 57 and arranging the LED substrate 34 in thermal connecting. Therefore, heat from the lighting circuit 39 and the LED substrate 34 (the LEDs 86) is dispersed to the lid portion 57 and the arrangement portion 58, and the surface area of the thermal radiating body 32 may be increased. In this manner, the thermal radiation is achieved with a simple configuration effectively.

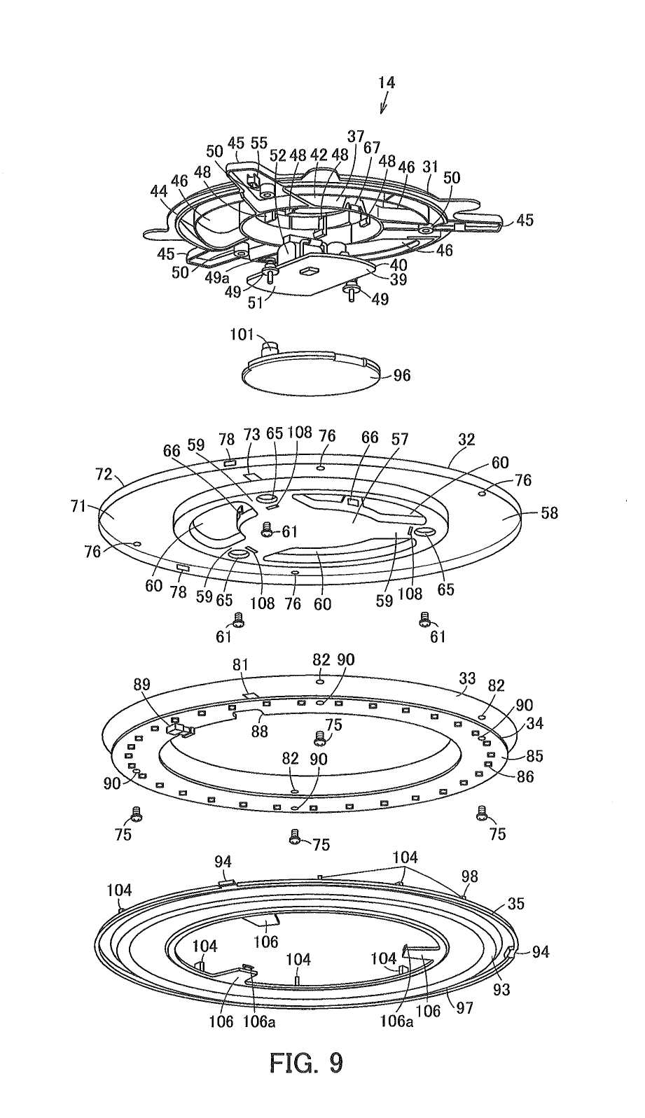

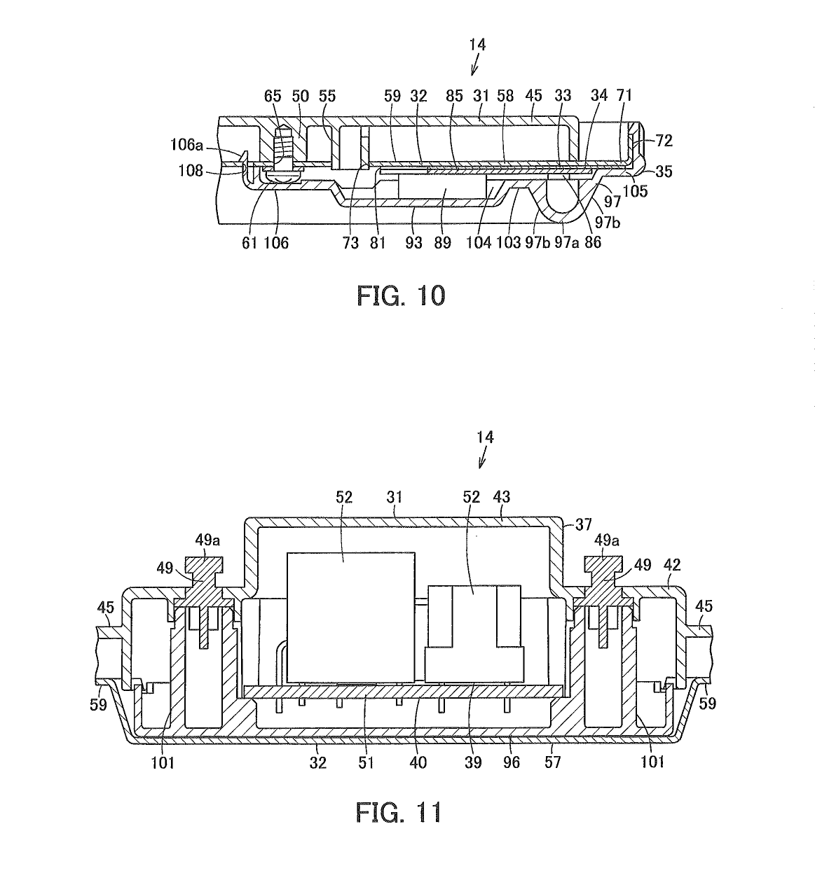

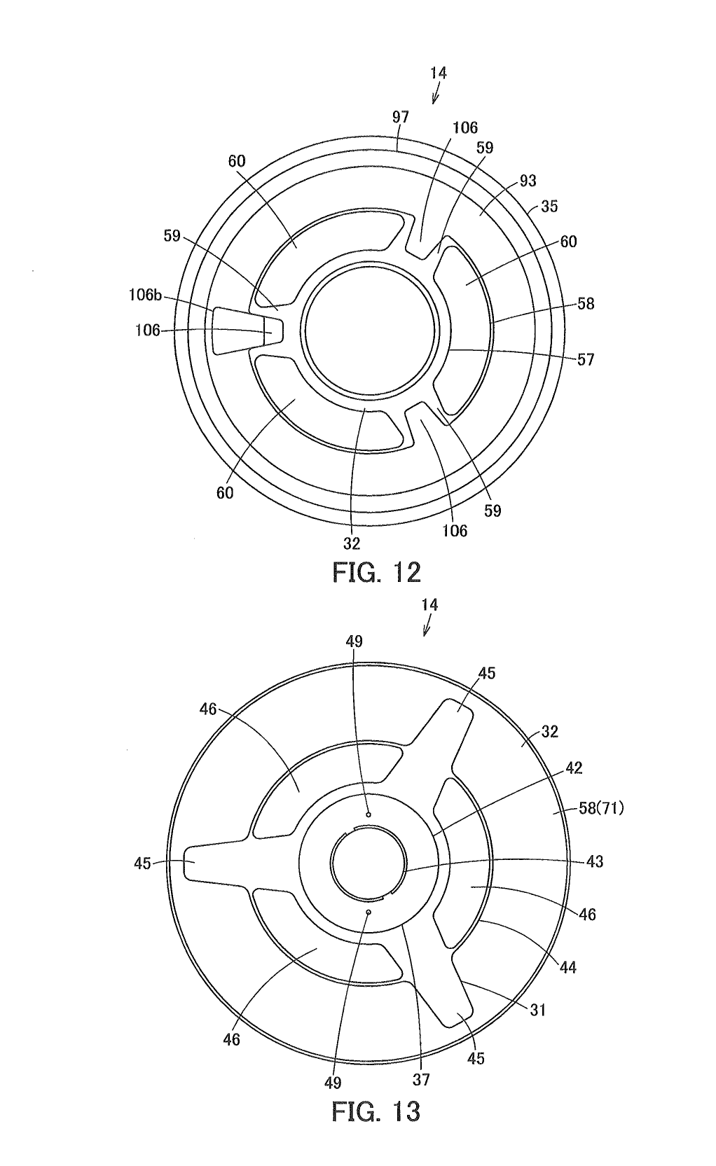

Referring now to FIG. 9 to FIG. 13, a second embodiment will be described. The same configuration and operation as those in the first embodiment given above are designated by the same reference numerals and description thereof is omitted.

The LED lamp 14 of the second embodiment is configured in such a manner that the storage 31 includes the storage body 37 and a separate lid member 96 formed of a synthetic resin for covering the storage body 37, and the cover 35 includes a lens portion 97 configured to diffuse light emitted from the respective LEDs 86 of the LED substrate 34 and a holding portion 98 configured to hold the LED substrate 34 upon the thermal radiating body 32.

In the storage 31, the screw receiving portions 50 of the storage body 37 are arranged in the respective coupling arm portions 45. The lid member 96 is formed into a disk shape configured to cover and close a lower side of the base body portion 42 of the storage body 37. Furthermore, the lid member 96 is provided with a boss-shaped electrode pin holding portion 101 configured to support the respective electrode pins 49 so as to project from the upper portion thereof. Therefore, the lid member 96 is thermally connected to the storage body 37 in a state of being mounted on the storage body 37. A lower surface of the lid member 96 comes into surface contact with the lid portion 57 of the thermal radiating body 32 and is in tight contact therewith over the entire surface.

The cover 35 is provided with the lens portion 97 continuing in an annular shape at a position facing the LEDs 86 of the LED substrate 34 of the covering portion 93, that is, at a position corresponding to the imaginary circle C. Furthermore, the cover 35 is formed with an inner holding portion 103 as a first holding portion which constitutes part of the holding portion 98 at a position on an inner peripheral side of the lens portion 97, and a holding rib 104 as a second holding portion which constitutes part of the holding portion 98 at a position on an inner peripheral side of the inner holding portion 103. Also, formed on an outer peripheral side of the lens portion 97 of the cover 35, that is, on an outer peripheral edge side of the cover 35 is a flat planar portion 105 coming into tight contact with the arrangement surface portion 71 of the arrangement portion 58 of the thermal radiating body 32 so as to continue over the entire circumference. The cover 35 is provided with locking arm portions 106 as a plurality of, for example, three cover locking portions for locking the cover 35 to the thermal radiating body 32 on an inner peripheral edge of the cover 35 so as to project radially toward a center portion.

The lens portion 97 projects downward, which corresponds to the thickness direction of the cover 35, and has an arcuate cross section. A top portion 97a of the lens portion 97 is located right below the LEDs 86 so as to face the LEDs 86 respectively and, from the top portion 97a, oblique outgoing surfaces 97b and 97b are formed on the inner peripheral side and an outer peripheral side of the cover 35.

The holding portion 98 is configured to transfer heat of the LED substrate 34 to the thermal radiating body 32 (the arrangement portion 58) further reliably by holding the substrate body 85 of the LED substrate 34 down upon the arrangement portion 58 (the arrangement surface portion 71) of the thermal radiating body 32 in a state in which the thermal radiating body 32 is mounted on the storage 31.

The inner holding portion 103 is formed into a circular flat plate shape at positions continuing to the outgoing surface 97b of the lens portion 97 on the inner peripheral side thereof, that is, continuing over the entire circumference of an inner peripheral edge of the lens portion 97.

The respective holding ribs 104 is formed so as to project radially on an upper surface which corresponds to a back surface of the cover 35 along the radial direction respectively, and are provided apart from each other at substantially regular intervals.

The planar portion 105 continues so as to project in a flange shape on the outer peripheral side of the lens portion 97.

The respective locking arm portions 106 are formed so as to project at positions corresponding to the respective coupling portions 59 of the thermal radiating body 32 and are formed so as to be gradually narrower from the proximal end sides to the distal sides thereof. Claw portions 106a are provided on upper portions of the respective locking arm portions 106 on the distal end side so as to project toward an inner peripheral side. The claw portions 106a of the locking arm portions 106 are configured to be inserted into and locked to square hole shaped locking opening portions 108 provided in the vicinity of the outer peripheral edge of the lid portion 57 of the coupling portions 59 of the thermal radiating body 32. Furthermore, any one of the locking arm portions 106 is formed with interference preventing portions 106b configured to avoid the interference with the connector receiving portion 89, the respective wires 54 and the connector 56 or the like mounted on the LED substrate 34 so as to protrude downward.

When mounting on the thermal radiating body 32, the cover 35 holds the LED substrate 34 down upon the arrangement portion 58 of the thermal radiating body 32 by bonding the holding portion 98 and the planar portion 105 or the like and the cover 35 is thermally connected to the LED substrate 34. In this state, the lens portion 97 of the cover 35 faces the LEDs 86 (the screws 75). In other words, the screws 75 are located inside the lens portion 97 of the cover 35.

Since linear light from the LEDs 86 may be diffused by the lens portion 97 projecting in the thickness direction of the cover 35 so as to face the LEDs 86, a wide light distribution may be realized, and alternative usage of the existing light source is enabled. By holding the LED substrate 34 down upon the thermal radiating body 32 by the holding portion 98, further reliable fixation of the LED substrate 34 with respect to the thermal radiating body 32 is ensured, and heat from the LED substrate 34 (the LEDs 86) is transferred further effectively to the thermal radiating body 32 and the LED substrate 34 (the LEDs 86) and the cover 35 are thermally connected via the holding portion 98 directly, so that the heat from the LED substrate 34 (the LEDs 86) may be radiated also from the cover 35. Consequently, the temperature of the LEDs 86 may further be reduced and the efficiency of the LED lamp 14 can further be increased.

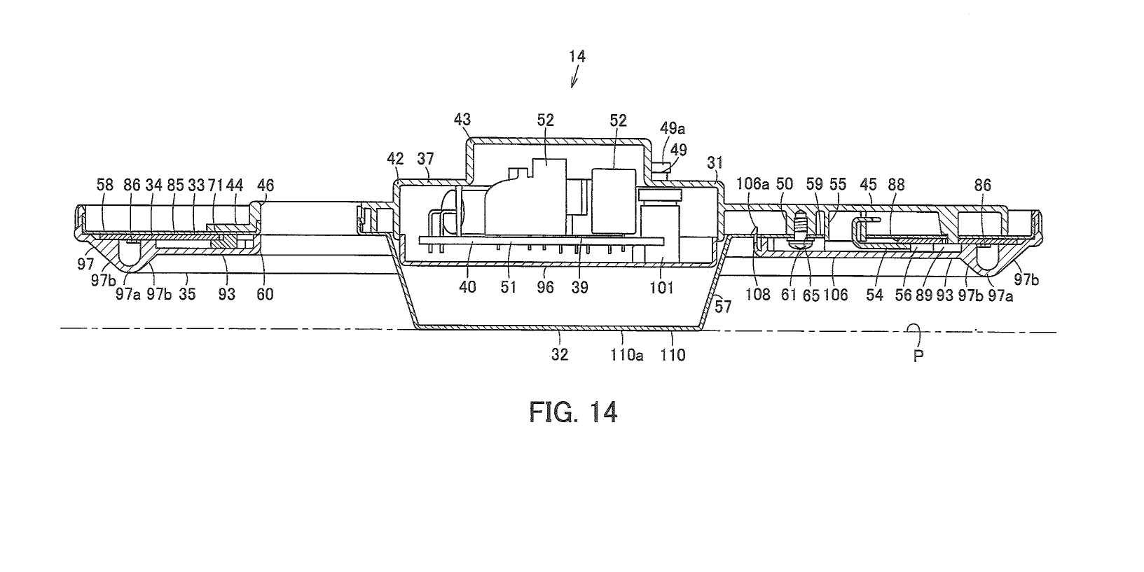

In the second embodiment, the lid portion 57 of the thermal radiating body 32 may be configured as a protruding portion 110 projecting downward of the lens portion 97 (the top portion 97a of the lens portion 97), that is, in the direction of thickness of the cover 35 as those of a third embodiment illustrated in FIG. 14. A lower end portion 110a of the protruding portion 110, which corresponds to a placing surface, is formed into a planar shape, and is configured to achieve a stable placement of the LED lamp 14 on a plane P. Then, when the LED lamp 14 is placed on the plane P via the lower end portion 110a of the protruding portion 110 with the storage 31 side located on the upper side in this manner, since the protruding portion 110 (the lid portion 57) projects downward of the lens portion 97, scratches or damage of the lens portion 97 may be prevented without interference of the lens portion 97 with the plane P.

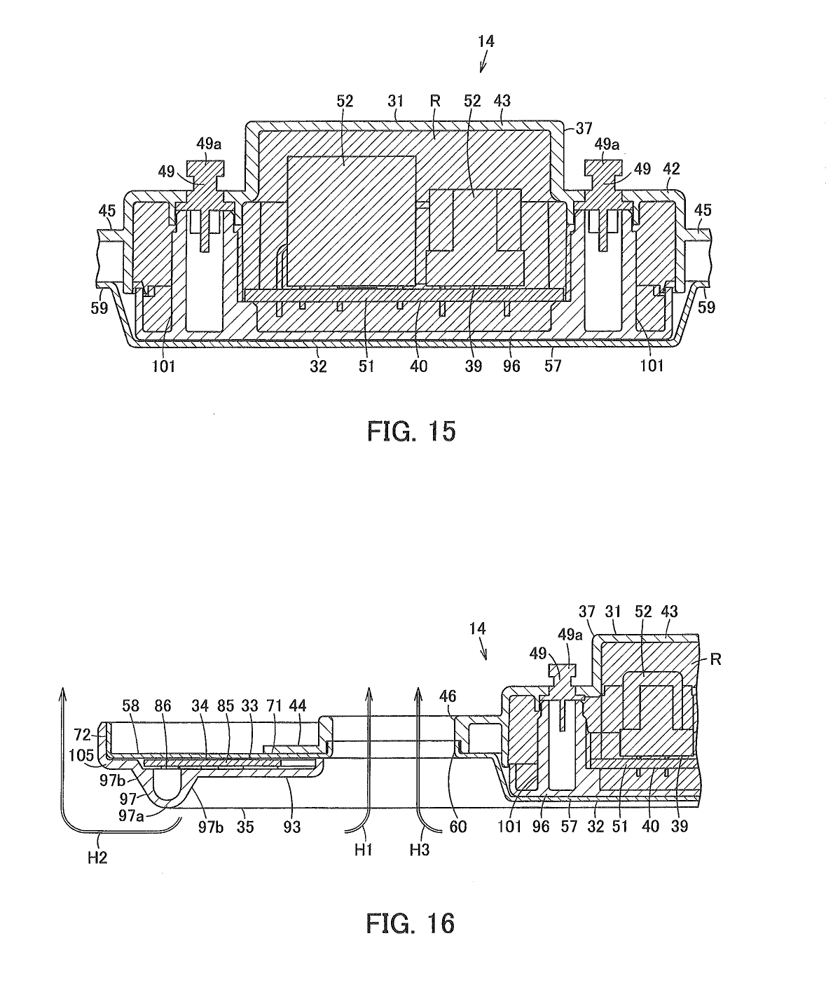

In the respective embodiments described above, the lighting circuit 39 (the power supply substrate 40) and the lid portion 57 of the thermal radiating body 32 may be thermally connected directly by filling the interior of the storage 31 with a resin R which corresponds to a thermal radiating member having thermal radiation properties and the thermal conductivity such as high thermal conductive silicone (heat radiating silicone) as in a fourth embodiment illustrated in FIG. 15 and FIG. 16. In such a case, the thermal convection is generated in the both directions (the arrows H1, H2) toward an inner periphery and an outer periphery of the arrangement portion 58 of the thermal radiating body 32 that receives heat from the LED substrate 34 (the LEDs 86), and the thermal convection is generated from the lid portion 57 of the thermal radiating body 32 that receives the heat from the lighting circuit 39 directly toward the outer peripheral (an arrow H3). In other words, heat generated from the LED substrate 34 (the LEDs 86) and the lighting circuit 39 flows into the identical openings 60 provided between the lid portion 57 and the arrangement portion 58, respectively. Consequently, stronger thermal convection is generated at the openings 60 owing to synergetic effect of the both flows of heat, so that the heat generated from the LED substrate 34 (the LEDs 86) may be radiated further effectively to the atmospheric air.

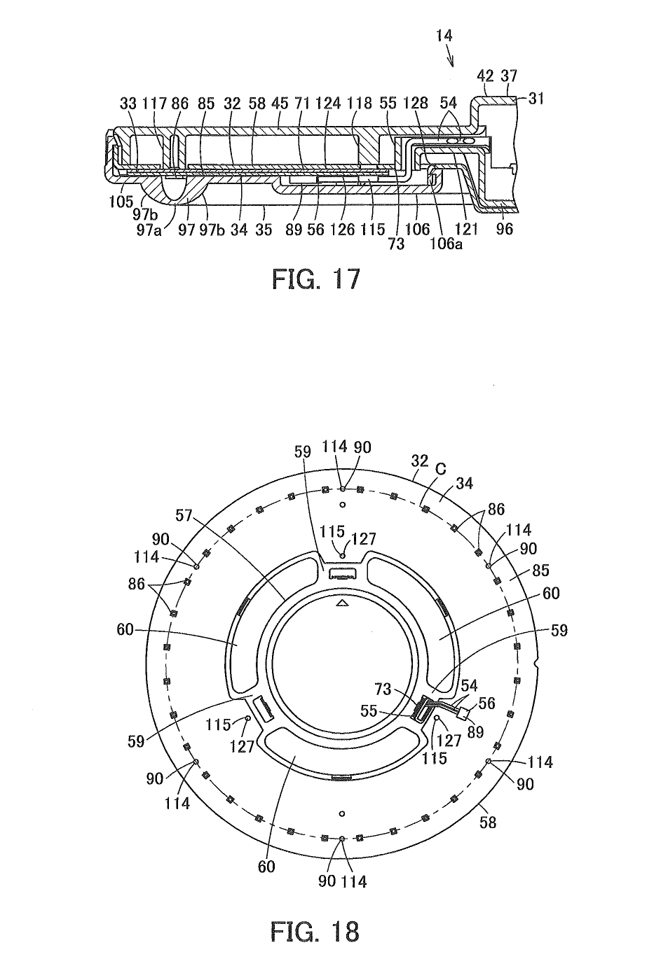

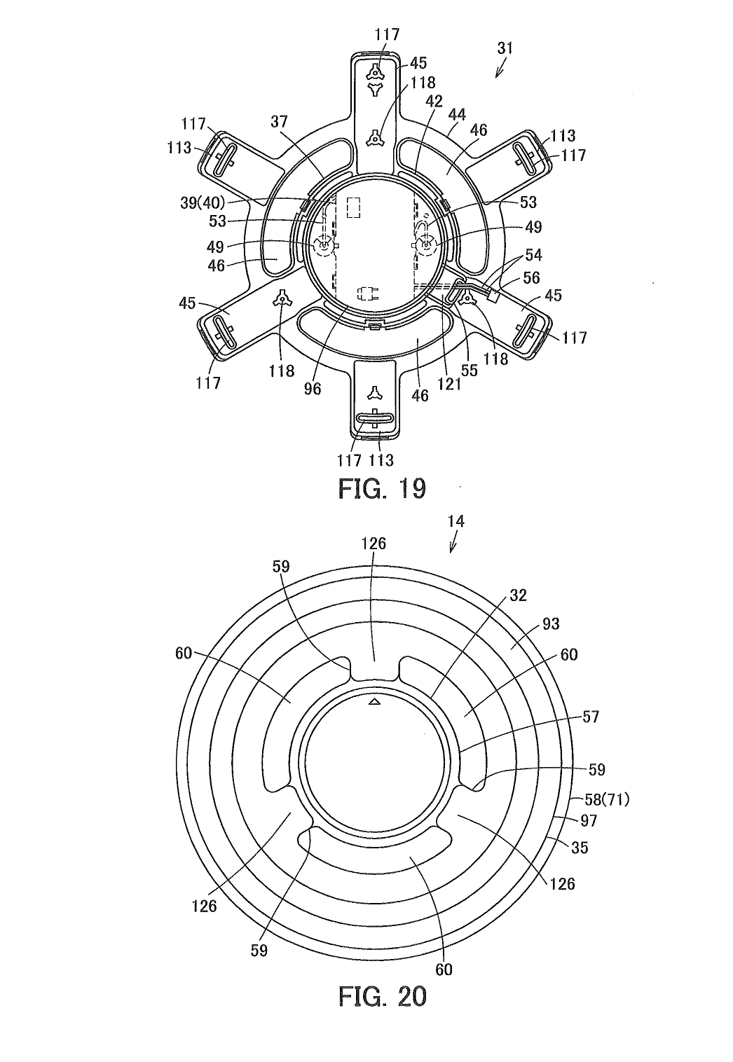

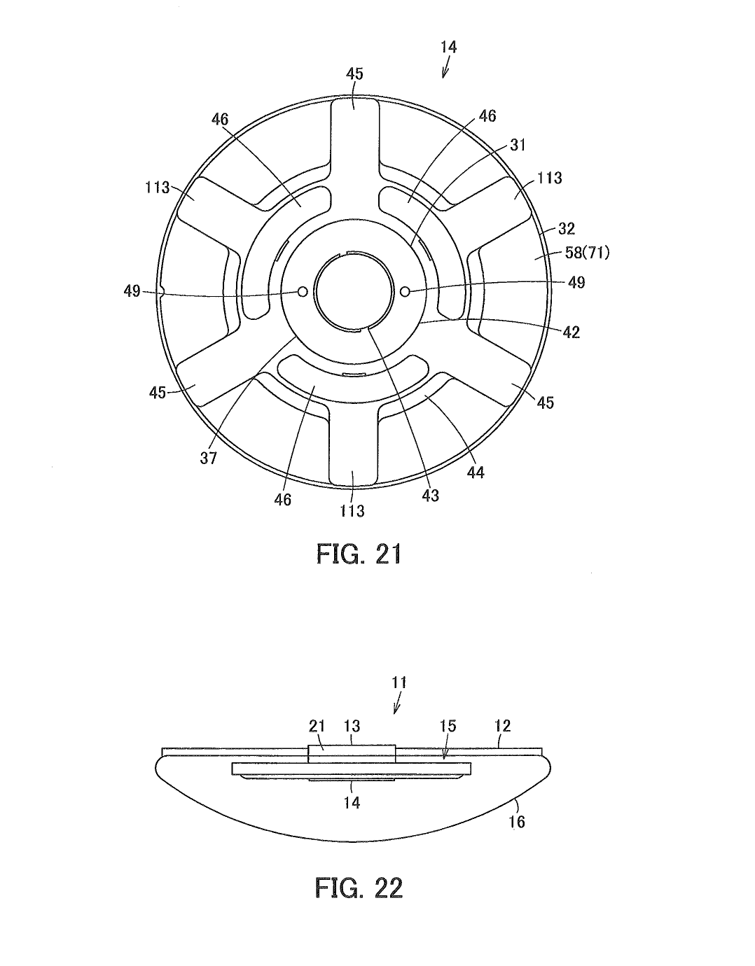

Referring now to FIG. 17 to FIG. 21, a fifth embodiment will be described. The same configuration and operation as those in the embodiments given above are designated by the same reference numerals and the description thereof is omitted.

The LED lamp 14 of the fifth embodiment is configured in such a manner that the storage 31 is provided with supporting portions 113 respectively between the coupling arm portions 45 and 45 of the storage body 37, the lid member 96 is provided with the wire insertion portion 55, and the LED substrate 34 and the thermal radiating body 32 are mounted on and fixed to the storage 31 by screws 114 and 115 as common fixing members.

The respective supporting portions 113 are formed so as to project from the peripheral edge portion 44 radially outward along the radial direction of the storage 31, and is located in the middle between the coupling arm portions 45 and 45. Therefore, the coupling arm portions 45 and the supporting portions 113 are apart from each other at substantially regular intervals. The respective supporting portions 113 and the respective coupling arm portions 45 are provided with screw receiving portions 117 where the screws 114 are screwed at positions in the vicinities of the distal ends thereof so as to project therefrom respectively, and the respective coupling arm portions 45 are provided with screw receiving portions 118 where the screws 115 are screwed at positions on the proximal end side so as to project therefrom respectively.

The lid member 96 is provided with a tongue-shaped projecting portion 121 to be fitted to any one of the coupling arm portions 45 so as to project therefrom radially along the radial direction, and a distal end side of the projecting portion 121 extend to position in the vicinity of the screw receiving portions 118. Furthermore, the square tubular shaped wire insertion portion 55 is integrally formed at the distal end side of the projecting portion 121. The wire insertion portion 55 is inserted into the opening 73 provided at a position of any one of the coupling portions 59 of the thermal radiating body 32 and projects on the distal end side thereof downward which is the cover 35 side with respect to a lower surface of the coupling portions 59 of the thermal radiating body 32. Then, the wires 54 from the lighting circuit 39 (the power supply substrate 40) are inserted through the wire insertion portion 55 along between the projecting portion 121 and the coupling arm portions 45, and are led out toward the LED substrate 34.

The thermal radiating body 32 is provided with screw holes, not illustrated, which allows insertion of the screws 115 therethrough on the respective coupling portions 59 in addition to the screw holes 76 which allow insertion of the screws 114.

The insulating sheet 33 is provided with the communication holes 82 which allow insertion of the screws 114 at positions corresponding to the respective coupling arm portions 45 and the respective supporting portions 113 of the storage 31. Furthermore, the insulating sheet 33 is provided with sheet extending portions 124 respectively so as to extend at positions corresponding to the respective coupling arm portions 45 on the inner peripheral edge thereof, and the sheet extending portions 124 are provided with communicating holes, not illustrated, which allow insertion of the screws 115, respectively.

The LED substrate 34 is also provided with extending portions 126 so as to extend at positions corresponding to the respective coupling arm portions 45 of the inner peripheral edge of the substrate body 85, respectively. The substrate body 85 is provided with the communication holes 90 which allow insertion of the screws 114 at positions corresponding to the respective coupling arm portions 45 and the respective supporting portions 113 of the storage 31 respectively, and through holes 127 which allow insertion of the screws 115 on the respective extending portions 126.

The claw portions 106a of the respective locking arm portions 106 of the cover 35 project outward of the cover 35, and are configured to be locked to looped locking projections 128 provided on the respective coupling portions 59 of the thermal radiating body 32 in the vicinities of the outer peripheral edge of the lid portion 57 so as to extend upright therefrom.

When assembling the LED lamp 14, first of all, the power supply substrate 40 (the lighting circuit 39) is inserted into and held in the storage body 37 of the storage 31, and then the respective electrode pins 49 and the power supply substrate 40 (the lighting circuit 39) are electrically connected by the respective wires 53.

Subsequently, the lid member 96 is mounted on the storage body 37 by being fitted thereto. At this time, the respective wires 54 led out from the power supply substrate 40 (the lighting circuit 39) are inserted into the wire insertion portion 55 formed on the projecting portion 121 of the lid member 96 and are led out to the outside (the lower side) of the lid member 96.

Subsequently, the thermal radiating body 32, the insulating sheet 33 and the LED substrate 34 are mounted on the storage 31. At this time, the screw holes 76 of the thermal radiating body 32, the communication holes 82 of the insulating sheet 33, and the through hole 90 of the LED substrate 34 are aligned with the respective screw receiving portions 117, and screw holes, not illustrated, of the thermal radiating body 32, communication holes, not illustrated, of the insulating sheet 33, and the through holes 127 of the LED substrate 34 are aligned to the respective screw receiving portions 118 and are integrally fixed by the screws 114 and 115. In this state, the respective sheet extending portions 124 of the insulating sheet 33 and the respective extending portions 126 of the LED substrate 34 are overlapped on the respective coupling portions 59 of the thermal radiating body 32, and the wire insertion portion 55 is inserted into the opening 73 at a position on the center portion side with respect to any one of the sheet extending portions 124 and any one of the extending portions 126, and the wires 54 and the connector 56 are led out through the wire insertion portion 55. Then, the lighting circuit 39 is electrically connected to the respective LEDs 86 by connecting the connector 56 to the connector receiving portion 89.

Then, the cover 35 is mounted on the thermal radiating body 32 so as to cover the LED substrate 34. At this time, the cover 35 aligns the respective locking openings 78 of the thermal radiating body 32 with the respective locking claw portions 94 and pushes the claw portions 106a of the respective locking arm portions 106 toward the respective locking projections 128 of the thermal radiating body 32 while aligning therewith, so that the respective locking claw portions 94 and the respective claw portions 106a are locked to the respective locking openings 78 and the respective locking projection 128. Consequently, the lens portion 97 of the covering portion 93 of the cover 35 is brought into a state of facing the respective LEDs 86 of the LED substrate 34.

The LED lamp 14 assembled in this manner is mounted on the socket 13 (the luminaire body 12) via the respective electrode pins 49 and is electrically connected to the external power supply (commercial power supply), and the globe 16 is mounted on the luminaire body 12 so as to cover the LED lamp 14, so that the luminaire 11 is completed.

Power supplied from the external power supply (commercial power supply) to the lighting circuit 39 via the respective electrode pins 49 by the socket 13 is converted by the lighting circuit 39 and supplied to the respective LEDs 86, so that the LEDs 86 are turned ON. The light emitted from the respective LEDs 86 is irradiated as uniform light by being diffused by the lens portion 97 of the cover 35, and being diffused by the globe 16.

Heat from the lighting circuit 39 is transferred to the lid portion 57 of the thermal radiating body 32 which covers the lighting circuit 39, and heat from the LED substrate 34 (the LEDs 86) is transferred from the base body 85 to the arrangement portion 58 of the thermal radiating body 32 via the insulating sheet 33. Therefore, the heat generating area is separated by the lighting circuit 39 and the LED substrate 34 (the LEDs 86), and local (partial) trapping (accumulation) of heat is minimized. Simultaneously, the thermal radiating body 32 secures a large surface area owing to the lid portion 57 and hence radiate heat from the LED substrate 34 (the LEDs 86) effectively to the atmospheric air.

In this manner, since the wire insertion portion 55 is formed on the lid member 96 having such a simple shape as the circular (disk shape, the wire insertion portion 55 may be formed easily, and the shape of the storage body 37 may be simplified in comparison with the case where the wiring insertion portion is provided on the storage body 37 of the storage 31, so that the storage body 37 may be manufactured at low cost.

Since the thermal radiating body 32, the insulating sheet 33, and the LED substrate 34 are fixed to the storage 31 with the common screws 114 and 115, the assembling work of the LED lamp 14 is easy, and the number of components may be reduced, and the light-weight and low-cost configuration is realized.

Furthermore, according to the second to fifth embodiments described above, head portions of the screws 75 or the screws 114 are located inside the lens portion 97 and are located at positions facing the lens portion 97 by fixing the LED substrate 34 with respect to the thermal radiating body 32 with the screws 75 or the screws 114 at positions of the row of the LEDs 86 arranged in a line on the predetermined row (the imaginary circle C) on the substrate body 85 of the LED substrate 34. Therefore, formation of a configuration for avoiding interference between the screws 75 or the screws 114 and the cover 35 on the cover 35 is not necessary, and hence the configuration of the cover 35 may further be simplified. In addition, variations in light distribution characteristics due to the cost reduction and the cover 35 hardly occur. In addition, since the LED substrate 34 is fixed by being held upon the thermal radiating body 32 at the positions corresponding to the LEDs 86 which generate heat most on the LED substrate 34, the heat from the LEDs 86 may be transferred further effectively to the thermal radiating body 32.

The storage 31 is provided with the lid member 96 thermally connected to the storage body 37 so as to cover the storage body 37 having the lighting circuit 39 (the power supply substrate 40) stored in the interior thereof. Therefore, by bringing the lid portion 57 of the thermal radiating body 32 into tight contact with the lid member 96, heat from the lighting circuit 39 may be transferred more reliably to the lid portion 57 of the thermal radiating body 32 via the lid member 96, so that further improvement of the thermal radiation properties is achieved.

In the embodiments described above, the globe 16 may be curved into a spherical shape as that of a sixth embodiment illustrated in FIG. 22.

The electronic components 52 of the power supply substrate 40 may be composed only of lead-mounted components or only of surface-mounted components. When composing the electronic components 52 only of the lead-mounted component, the power supply substrate 40 may be mounted only in one step of flow steps by mounting the electronic components 52 on one surface of the power source substrate body 51. When composing the electronic components 52 only of the surface-mounted (SMD) components, the power supply substrate 40 may be formed only in one step of reflow steps together with the LED substrate 34.

In addition, as the light source, for example, organic EL elements, or solid light-emitting elements such as semiconductor lasers or planer fluorescent lamp may be used in addition to the LEDs 86.

The substrate body 85 of the LED substrate 34 may be divided into a plurality of pieces.

In addition, the configuration in which the cover 35 is mounted on the thermal radiating body 32 may be set arbitrarily. The cover 35 is not limited to be fixed to the thermal radiating body 32, but may be configured to be mounted in the storage 31.

According to at least any one of the embodiments described above, the thermal radiating body 32 is integrally provided with the lid portion 57 configured to cover the storage 31 in which the lighting circuit 39 is stored in the interior thereof and the arrangement portion 58 located in the periphery of the lid portion 57 and configured to arrange the LED substrate 34 in thermal connection. Therefore, heat from the lighting circuit 39 and the LED substrate 34 (the LEDs 86) is dispersed to the lid portion 57 and the arrangement portion 58 to prevent local concentration of the heat, and the surface area of the thermal radiating body 32 may be increased. In this manner, the thermal radiation is achieved with a simple configuration effectively. Therefore, the configuration in the embodiments may accommodate increase in amount of heat generation in association with increased efficiency of the LED lamp 14, and improvement of the efficiency of the LED lamp 14 is enabled.

Since the arrangement portion 58 of the thermal radiating body 32 that receives the heat from the LED substrate 34 (the LEDs 86) is formed into an annular shape, the thermal convection is generated in both directions toward the inner peripheral side and the outer peripheral side. Therefore, the amount of the thermal convection is significantly increased, and hence further effective thermal radiation is enabled. In addition, by air passing through the openings 60 opening between the lid portion 57 configured to cover the lighting circuit 39 of the thermal radiating body 32 and the arrangement portion 58 on which the LED substrate 34 is arranged, improvement of the thermal radiation properties of the thermal radiating body 32 owing to the thermal radiation and air circulation is achieved, and the weight reduction and cost reduction of the thermal radiating body 32 is enabled.

In addition, by forming the wire insertion portion 55 to be inserted into the opening 73 provided on the metallic thermal radiating body 32 and project from the opening 73 toward the cover 35 in the storage 31 formed of a resin, and inserting the respective wires 54 to electrically connect the lighting circuit 39 and the LED substrate 34 through the wire insertion portion 55, interference of the respective wires 54 with the edge portion of the opening 73 of the metallic thermal radiating body 32 is prevented by the resin-made wire insertion portion 55. Therefore, the respective wires 54 may be protected from breaking or the like without giving damage to the respective wires 54 due to a friction of the respective wires 54 with the edge portion of the opening 73, so that the reliability may further be improved.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A lamp comprising:
a lighting circuit;
a storage provided with a pair of electrode pins electrically connected to the lighting circuit and having an interior in which the lighting circuit is stored;
a thermal radiating body integrally provided with a lid portion configured to cover the interior of the storage and an outer portion located along a periphery of the lid portion;
a light source substrate including light sources configured to emit light upon receipt of power supplied from the lighting circuit, the light source substrate being thermally coupled to the outer portion of the thermal radiating body; and
a translucent cover configured to cover the light source substrate.

2. The lamp according to claim 1, wherein the thermal radiating body includes an opening configured to allow passage of air between the lid portion and the outer portion.

3. The lamp according to claim 1, wherein the translucent cover includes:
a lens portion arranged to face the light sources and projecting away therefrom, and configured to diffuse light emitted from the light sources; and
a holding portion configured to hold down the light source substrate against the thermal radiation body.

4. The lamp according to claim 3, wherein the lid portion projects away from the interior of the storage.

5. The lamp according to claim 3 wherein
the light sources are arranged at regular intervals on the light source substrate.

6. The lamp according to claim 3 further comprising:
fixing members configured to fix the light source substrate to the thermal radiating body at a position that is between two of the light sources and inwardly of the lens portion.

7. The lamp according to claim 1, wherein the thermal radiating body includes an opening, and
the storage includes a wire insertion portion that is formed of a resin, is inserted into the opening, projects from the opening towards the cover, and allows insertion of a wire for electrically connecting the lighting circuit and the light source substrate.

8. The lamp according to claim 1, wherein the storage includes a lid member; and
the wire insertion portion is provided on the lid member.

9. The lamp according to claim 1, further comprising a thermal radiating member filled in the interior of the storage to thermally couple the lighting circuit and the lid portion.

10. The lamp according to claim 1, wherein the storage, the thermal radiating body, and the light source substrate are fixed to each other with a common screw.

11. The lamp according to claim 1, wherein the light sources are LEDs.

12. A lamp unit comprising:
a socket;
a lighting circuit;
a storage provided with a pair of electrode pins electrically connected to the lighting circuit and the socket, and having an interior in which the lighting circuit is stored;
a thermal radiating body integrally provided with a lid portion configured to cover the interior of the storage and an outer portion located along a periphery of the lid portion;
a light source substrate including light sources configured to emit light upon receipt of power supplied from the lighting circuit, the light source substrate being thermally coupled to the outer portion of the thermal radiating body; and
a translucent cover configured to cover the light source substrate.

13. The lamp unit according to claim 12, wherein the thermal radiating body includes an opening configured to allow passage of air between the lid portion and the outer portion.

14. The lamp unit according to claim 12, wherein the thermal radiating body includes an opening, and
the storage includes a wire insertion portion that is formed of a resin, is inserted into the opening, projects from the opening towards the cover, and allows insertion of a wire for electrically connecting the lighting circuit and the light source substrate.

15. The lamp unit according to claim 12, further comprising a thermal radiating member filled in the interior of the storage to thermally couple the lighting circuit and the lid portion.

16. A method of assembling a lamp comprising:
inserting a lighting circuit of the lamp into an interior of a storage provided with a pair of electrode pins and electrically connecting the lighting circuit to the pins;
mounting a thermal radiating body having a lid portion and an outer portion on the storage to cover the interior of the storage with the lid portion;
mounting a light source substrate including light from the lighting circuit on the outer portion of the thermal radiating body to thermally couple the light source substrate thereto; and
covering the light source substrate with a translucent cover.

17. The method according to claim 16, further comprising:
electrically connecting the light circuit with the light sources with wires.

18. The method according to claim 17, wherein the storage includes a wire insertion portion that is formed of a resin and projects through an opening in the thermal radiating body, and the wires that electrically connect the light circuit with the light sources are inserted in the wire insertion portion.

19. The method according to claim 16, further comprising filling the interior of the storage with a thermal radiating member to thermally couple the lighting circuit and the lid portion.

20. The method according to claim 16, further comprising fixing the storage, the thermal radiating body, and the light source substrate to each other with a single screw.
